(19) United States
(12) Patent Application Publication
(10) Pub. No.: US 2012/0164964 A1
(43) Pub. Date: Jun. 28, 2012

(54) APPARATUS FOR RADIO CHANNEL MEASUREMENT USING MULTIPLE-ANTENNA SYSTEM

(75) Inventors: Heon-Kook KWON, Daejeon (KR); Jae-Ho JUNG, Daejeon (KR); Hyun-Kyn CHUNG, Daejeon (KR)

(73) Assignee: Electronics and Telecommunications Research Institute, Daejeon (KR)

(21) Appl. No.: 13/329,922

(22) Filed: Dec. 19, 2011

(30) Foreign Application Priority Data
Dec. 22, 2010 (KR) 10-2010-0132524

(51) Int. Cl. H04B 17/00

(52) U.S. Cl. 455/226.1

(57) ABSTRACT

Provided is a radio channel measurement apparatus including: a multiple-antenna system including at least two antennal elements; a single-path processor; and a multiple-path processor to partition the at least two antenna elements into a predetermined number of groups, to sequentially amplify signals received through the at least two antenna elements for each group, and to sequentially output the amplified signals to the single-path processor.

### CROSS-REFERENCE TO RELATED APPLICATION

This application claims the benefit under 35 U.S.C. §119(a) of a Korean Patent Application No. 10-2010-0132524, filed on Dec. 22, 2010, the entire disclosure of which is incorporated herein by reference for all purposes.

### BACKGROUND

1. Field

The following description relates to an apparatus for radio channel measurement, and more particularly, to an apparatus for radio channel measurement using a multiple-antenna system.

2. Description of the Related Art

In order to model a radio spatial channel in development of a mobile communication system, a process of measuring the radio spatial channel and extracting parameters of the radio spatial channel using the measured data has to be conducted. In the process, the radio spatial channel is measured by a channel sounder. However, since radio channel characteristics vary depending on frequency bands, topographical characteristics, climates, etc., the radio channels have to be measured under various environments, and accurate measurement data has to be attained and analyzed in order to model a radio channel with high reliability.

The channel sounder uses the channel property in which no channel change occurs during a coherent time to time-divisionally use multiple antennas and store data through a single receiving path.

In particular, a radio spatial channel measurement system using a multiple-antenna system may deduce the directionality of a radio wave, such as an Angle of Departure (AoD) and an Angle of Arrival (AoA), which is a unique property of a radio spatial channel, using a plurality of antennas arranged in a circle form, in a square form, etc., to measure signals received through each antenna via the radio spatial channel.

The directionality of the radio wave is extracted based on the magnitudes of the received signals and relative differences in phase between the antennas. The more the number of antennas included in the multiple-antenna system, the less the resolution and measurement errors of the AoD and AoA. Recently, a radio spatial channel measurement system which uses 64 or more antennas has been developed for performance enhancement. When a plurality of antennas are used, a switch for selecting one from among a plurality of paths is located at the next stage of the antennas in order to transfer signals received by the individual antennas to a single receiving path.

However, as the number of paths that are selected by the switch increase, RF matching becomes difficult, resulting in an increase of insertion loss. Also, in the case of a receiver, since a loss at the next stage of the antennas is added to noise figure (NF), the path loss of the switch deteriorates reception performance.

Since a radio channel measurement apparatus for measuring the directionality of a radio wave requires a large number of antennas to increase measurement accuracy, the path loss of switches increases, which further deteriorates the NF performance of a receiver.

If NF increases, a minimum receiving power is reduced, which shortens a distance at which the receiver of the radio channel measurement apparatus can measure signals.

### SUMMARY

The following description relates to a channel measurement apparatus using a multiple-antenna system, capable of minimizing noise figure (NF).

The following description also relates to a channel measurement apparatus using a multiple-antenna system, capable of accurately measuring an angle of departure (AoD) and an angle of arrival (AoA) of a radio wave through a plurality of antennas.

In one general aspect, there is provided a radio channel measurement apparatus including: a multiple-antenna system including at least two antennal elements; a single-path processor; and a multiple-path processor to partition the at least two antenna elements into a predetermined number of groups, to sequentially amplify signals received through the at least two antenna elements for each group, and to sequentially output the amplified signals to the single-path processor.

Therefore, by locating a low noise amplifier (LNA) as adjacent as possible to antennas, it is possible to minimize NF due to the low noise property and gain of the LNA. Also, by configuring a switch that can select multiple paths after the LNA, problems of conventional techniques can be overcome.

Accordingly, a receiver of a channel measurement system that time-divisionally uses a plurality of antennas may have improved NF. Also, since a minimum power that can be measured by the receiver is lowered, radio channel measurement over a wider range is possible.

Furthermore, it is possible to increase the number of multiple antennas without causing performance deterioration. That is, by minimizing the measurement resolution and measurement errors of an AoD and AoA of a radio wave that is measured by multiple antennas, without deteriorating performance, the propagation direction of the radio wave can be accurately measured.

Other features and aspects will be apparent from the following detailed description, the drawings, and the claims.

### BRIEF DESCRIPTION OF THE DRAWINGS

FIG. 1 is a diagram illustrating a general radio channel measurement apparatus using a multiple-antenna system.

FIG. 2 is a view for explaining a path loss that is generated in a radio frequency (RF) front end.

FIG. 3 is a diagram illustrating an example of a radio channel measurement apparatus using a multiple-antenna system.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

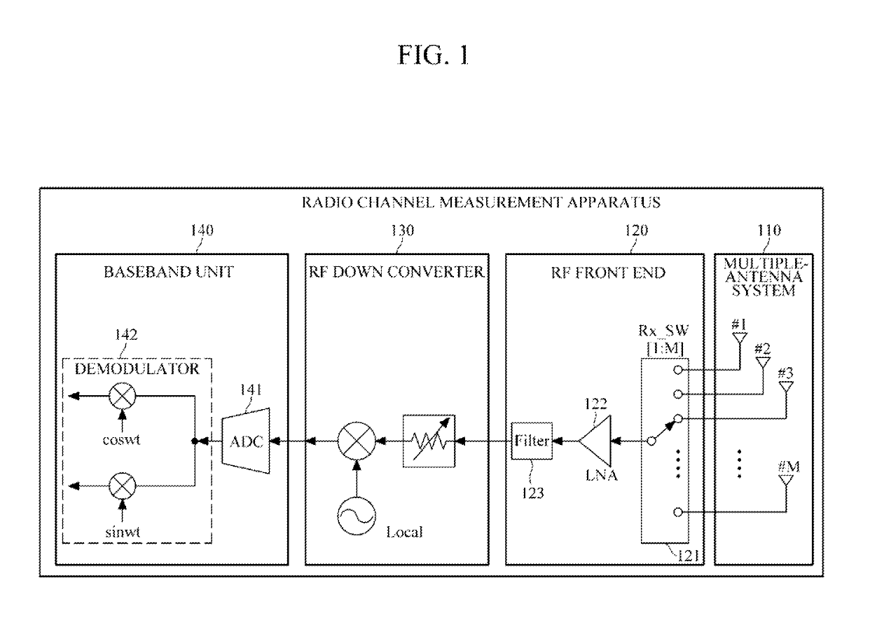

FIG. 1 is a diagram illustrating an example of a radio channel measurement apparatus using a multiple-antenna system.

Referring to FIG. 1, the radio channel measurement apparatus includes a multiple-antenna system 110, a radio frequency (RF) front end 120, an RF down converter 130, and a baseband unit (BBU) 140.

As illustrated in FIG. 1, the radio channel measurement apparatus has a single receiving path. In order to use the single receiving path to time-divisionally receive signals through the multiple-antenna system 110, the RF front end 120 includes a receiving antenna switch 121 for selecting an antenna element from among the multiple-antenna system 110.

The receiving antenna switch 121 has M input switching ports and an output port, wherein M corresponds to the number of antenna elements included in the multiple-antenna system 110. The receiving antenna switch 121 selects, when receiving an antenna switch signal, an RF signal from among RF signals received through the M input switching ports, and outputs the selected RF signal through the output port. The output port transfers the RF signal to a low noise amplifier (LNA) 122.

A receiver of a radio channel measurement apparatus has to have a very low measurement resolution and a very low measurement error of an angle of departure (AoD) and an angle of arrival (AoA) in order to accurately deduce the directionality (that is, an AoD and AoA) of a radio wave. In order to achieve this, it is preferable that the multiple-antenna system 100 includes as many antenna elements as possible.

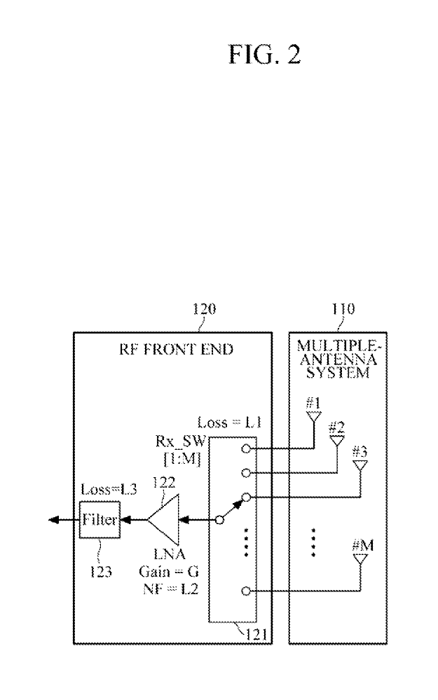

However, as illustrated in FIG. 1, as the number M of the antenna elements included in the multiple-antenna system 110 increases, the number of paths that are selected by the receiving antenna switch 121 also increases. Accordingly, a path loss of the receiving antenna switch 121 increases, resulting in deteriorating the entire noise figure (NF) of the receiver of the radio channel measurement apparatus. This will be described in more detail with reference to FIG. 2, below.

FIG. 2 is a view for explaining a path loss that is generated in the RF front end 120.

As illustrated in FIG. 2, if L1 is a path loss generated in the receiving antenna switch 121, L2 is a path loss generated in the LNA 122, and L3 is a path loss generated in a filter 123, the total NF is represented as equation 1 below.

$$NF = L 1 + L 2 + \frac{L 3}{G} , \qquad ( 1 )$$

where G is a gain of the LNA 122.

As seen from equation 1, the path loss L1 between the multiple-antenna system 110 and the LNA 122 is added to the NF. That is, the NF may be deteriorated by the path loss L1 of the receiving antenna switch 121.

However, if NF increases, a minimum receiving power is reduced, which shortens a distance at which the receiver of the radio channel measurement apparatus can measure signals. Accordingly, there occurs a problem that the number of antenna elements should be limited due to the path loss L1 of the receiving antenna switch 121.

In order to solve the problem of having to limit the number of antenna elements included in the multiple-antenna system, a radio channel measurement apparatus using a multiple-antenna system is proposed herein in which NF at the receiver does not significantly increase although the number of antenna elements of the multiple-antenna system increases.

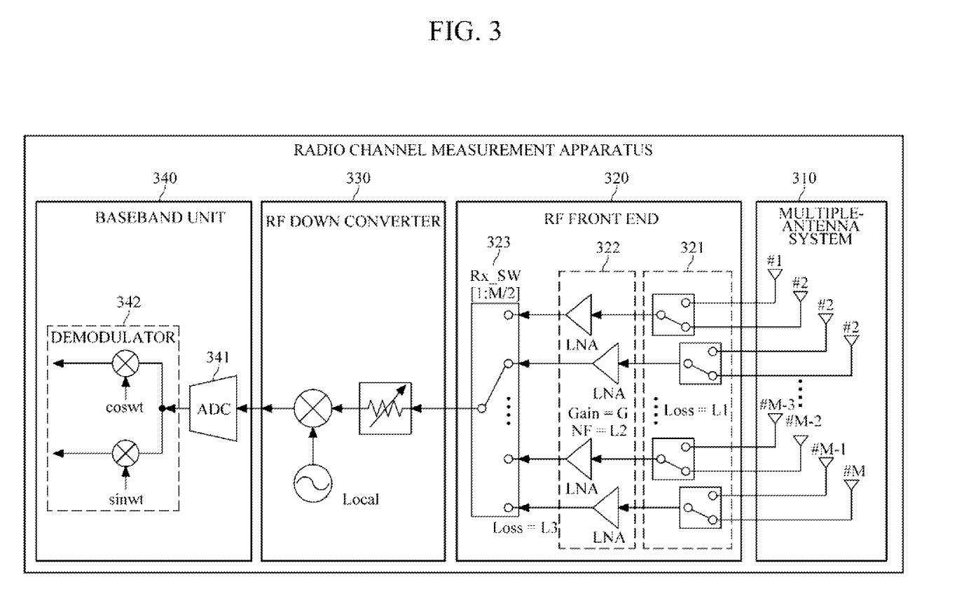

FIG. 3 is a diagram illustrating an example of a radio channel measurement apparatus using a multiple-antenna system 310.

Referring to FIG. 3, the radio channel measurement apparatus includes the multiple-antenna system 310, a multiple-path processor, and a signal path processor.

The multiple-path processor, which corresponds to an RF front end 320 of FIG. 3, sequentially processes multiple-path signals received through the multiple-antenna system 310 so that the signal path processor can process the multiple-path signals.

The multiple-path processor partitions two or more antennal elements included in the multiple-antenna system 310 into a predetermined number of groups, sequentially amplifies signals received through the antenna elements for each group, and sequentially outputs the amplified signals to the single-path processor.

The single-path processor includes an RF down converter 330 and a baseband unit (BBU) 340, and sequentially processes single-path signals output from the RF signal front end 320.

The RF signal front end 320 includes a plurality of receiving antenna switches 321, a low noise amplifier (LNA) 322, and a multiple-path switch 323.

The receiving antenna switches 321 are connected to two or more antenna elements included in the multiple-antenna system 310, sequentially switch signals received through the antenna elements, and output the signals. The receiving antenna switches 321 may be Single Pole Double Throw (SPDT) switches with low insertion loss. Each SPDT switch is connected to two antenna elements to switch the two antenna elements, and outputs a radio channel signal received from one of the two antenna elements to the LNA 322. In other words, each SPDP switch switches only two antenna signals, which leads to a reduction of a path loss.

The LNA 322 is composed of a plurality of LNA elements that are respectively connected to the receiving antenna switches 321, and each LNA element amplifies signals output from a receiving antenna switch and outputs the amplified signals.

The multiple-path switch 323 selects one from among a plurality of signals output from the individual LNA elements, and outputs the selected signal to the RF down converter 330 which is a single-path processor. Accordingly, the multiple-path switch 323 includes input switch ports having the same number as that of the receiving antenna switches 321 and as that of the LNA elements 322, and an output switch port.

For example, if the number of the antenna elements included in the multiple-antenna system 310 is M and the receiving antenna switches 321 are SPDT switches, the number of input switch ports of the multiple-path switch 323 becomes M/2. In other words, since a 1:M/2 switch is used compared to a conventional technique of using a 1: M switch, a path loss is reduced correspondingly. Moreover, since the multiple-path switch 323 is located after the LNA 322, the multiple-path switch 323 does little influence NF performance.

That is, referring to equation 1, L1, which is an insertion loss generated in the receiving antenna switch 321, is reduced compared to the conventional technique, while L3, which is an insertion loss generated in the multiple-path switch 323, having a relatively high insertion loss although it is lower than that of the conventional technique is divided by G and accordingly reduced sufficiently not so as to influence NF.

Accordingly, through the configuration of the RF front end 320 as described above, an increase of NF due to a large insertion loss of the receiving antenna switch 321 may be prevented. Furthermore, since the insertion loss of the receiving antenna switch 321 is maintained constant although the number of antennas increases, the NF of the receiver also may be maintained constant.

Meanwhile, the RF down converter 330 of the single-path processor down-converts a RF signal output from the multiple-path switch 323 and outputs the down-converted RF signal.

The BBU 340, which is a baseband processor for processing reception channel signals that are to be measured, includes an analog-to-digital converter (ADC) 341 and a demodulator 342.

The ADC 341 converts an input IF analog signal transferred from the RF down converter 330 to a digital signal.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A radio channel measurement apparatus comprising:
a multiple-antenna system including at least two antennal elements;
a single-path processor; and
a multiple-path processor to partition the at least two antenna elements into a predetermined number of groups, to sequentially amplify signals received through the at least two antenna elements for each group, and to sequentially output the amplified signals to the single-path processor.

2. The radio channel measurement apparatus of claim 1, wherein the multiple-path processor comprises:
at least two receiving antenna switches connected to the at least two antenna elements, to sequentially switch the at least two antenna elements and output a signal received through one of the at least two antenna elements;
a low noise amplifier including a plurality of low noise amplifier elements connected to the at least two receiving antenna switches, each low noise amplifier element amplifying a signal output from a receiving antenna switch connected to the low noise amplifier element and outputting the amplified signal;
a multiple-path switch to select a signal from among a plurality of signals output from the low noise amplifier elements and to output the selected signal to the single-path processor.

3. The radio channel measurement apparatus of claim 2, wherein the receiving antenna switches are Single Pole Double Throw (SPDT) switches each having two input switching ports and an output switching port.

4. The radio channel measurement apparatus of claim 2, wherein the multiple-path switch includes input switch ports having the same number as that of the receiving antenna switches and as that of the low noise amplifier elements, and an output switch port.
